(19) United States
(12) Patent Application Publication
(10) Pub. No.: US 2026/0259567 A1
(43) Pub. Date: Sep. 3, 2026

(54) OBSTACLE DETECTION AND CONTROL METHOD FOR UNDERWATER ROBOT, UNDERWATER ROBOT, AND MEDIUM

(71) Applicant: Shenzhen Seauto Technology Co., Ltd., Shenzhen (CN)

(72) Inventor: Zhineng Deng, Shenzhen, Guangdong (CN)

(21) Appl. No.: 18/994,809

(22) PCT Filed: May 12, 2023
(86) PCT No.: PCT/CN2023/093920

§ 371 Date: Jan. 15, 2025

(30) Foreign Application Priority Data
Apr. 4, 2023 (CN) 202310382400.2

(51) Int. Cl. G05D 1/622; B63G 8/00; G05D 1/648; G05D 105/10; G05D 107/00; G05D 109/30

(52) U.S. Cl. CPC G05D 1/622; B63G 8/001; G05D 1/648; B63G 2008/002; G05D 2105/10; G05D 2107/29; G05D 2109/38

(57) ABSTRACT

Disclosed are an obstacle detection and control method applied to an underwater robot, an underwater robot and a medium. The method is applied to an underwater robot, and the underwater robot includes an out-of-obstacle mechanism and a water pumping mechanism. The method includes the following steps: S10, when the underwater robot is executing a cleaning task, acquiring an acceleration detected by an acceleration sensor, and a distance value detected by a distance sensor; S20, when a variation of the acceleration within a preset time period is greater than a preset threshold and the distance value is greater than a distance threshold, determining that a first-type obstacle is at a current position; and S30, in response to that the first-type obstacle is determined at the current position, controlling the water pumping mechanism and the out-of-obstacle mechanism to execute a first escape action.

The present application claims priority to Chinese Patent Application No. 202310382400.2, filed with the China National Intellectual Property Administration on Apr. 4, 2023 and entitled “OBSTACLE DETECTION AND CONTROL METHOD FOR UNDERWATER ROBOT, UNDERWATER ROBOT, AND MEDIUM”, which is incorporated herein by reference in its entirety.

### TECHNICAL FIELD

The present application relates to the technical field of robots, and in particular, to an obstacle detection and control method for an underwater robot, an underwater robot, and a medium.

### BACKGROUND

An underwater robot may be used for a variety of underwater operations, such as repeatedly cleaning the bottom, walls and water lines of a swimming pool.

When an underwater robot is executing a swimming pool cleaning task, obstacles at the bottom of the pool affect the underwater robot to execute the cleaning task. For example, when there are foreign objects such as swimming goggles, slippers, or branches underwater, the underwater robot easily gets stuck and cannot move. Or when encountering fixed obstacles such as escalators and steps on the pool wall, the underwater robot changes the traveling direction due to the collision. This may cause the underwater robot to become trapped at a certain position or change the original traveling direction during the cleaning of the swimming pool, thereby affecting the cleaning range of the underwater robot.

The above contents are only used to assist in understanding the technical solution of the present application and do not constitute an admission that the above contents are prior art.

### SUMMARY

The present application provides an obstacle detection and control method applied to an underwater robot, an underwater robot, and a medium, which the cleaning range of the underwater robot is not affected if the underwater robot is trapped at a certain position or changes an original traveling direction in the cleaning process.

The present application provides an obstacle detection and control method applied to an underwater robot. The obstacle detection and control method for the underwater robot includes the following steps:
when the underwater robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining that a first-type obstacle is at a current position of the underwater robot; and
in response to that the first-type obstacle is determined at the current position, controlling a water pumping mechanism and an escape mechanism to execute a first escape action.

Optionally, controlling a water pumping mechanism and an escape mechanism to execute the first escape action in response to that the first-type obstacle is determined at a current position includes:
in response to that the first-type obstacle is determined at a current position, stopping the water pumping mechanism and starting the escape mechanism thereby switching an operating state of the underwater robot; and
controlling the underwater robot to execute the first escape action for a first preset duration when the operating state is switched.

Optionally, after acquiring the acceleration detected by the acceleration sensor and the distance value detected by the distance sensor during a process of executing a cleaning task, the method further includes:
when the variation of the acceleration within the preset time period is less than the preset threshold and the distance value is less than the distance threshold, determining that a second-type obstacle is at the current position of the underwater robot; and
in response to that the second-type obstacle is determined at the current position, controlling the water pumping mechanism to execute a second escape action.

Optionally, controlling the water pumping mechanism to execute a second escape action in response to that the second-type obstacle is determined at a current position includes:
in response to detecting that there is the second-type obstacle at a current position, controlling the water pumping mechanism to switch an operating state; and
controlling the underwater robot to execute the second escape action for a second preset duration when the operating state of the water pumping mechanism is switched.

Optionally, acquiring the current acceleration detected by the acceleration sensor and the distance parameter detected by the distance sensor during a process of executing a cleaning task, the method further includes:
when a variation of the acceleration within a preset time period is greater than the preset threshold and the distance value is less than the distance threshold, determining that a third-type obstacle is at the current position; and
in response to that the third-type obstacle is determined at the current position, controlling the water pumping mechanism and the escape mechanism to execute a third escape action.

Optionally, controlling the water pumping mechanism and the escape mechanism to execute the third escape action in response to that the third-type obstacle is determined at the current position includes:
in response to detecting that there is the third-type obstacle at a current position, stopping the water pumping mechanism and starting the escape mechanism by the underwater robot to execute the third escape action for a third preset duration; and
when the distance value is detected as zero (0), stopping the escape mechanism, starting the water pumping mechanism, and controlling the underwater robot to execute the third escape action for the third preset duration.

Optionally, the underwater robot includes a three-dimensional laser scanner, and before acquiring a current acceleration detected by the acceleration sensor and the distance value detected by the distance sensor when the underwater robot is executing the cleaning task, the method further includes:
scanning a swimming pool area by a three-dimensional laser scanner, and dividing the swimming pool area into a plurality of areas each of an equal size based on a swimming pool area that is scanned by the three-dimensional laser; and
generating the cleaning task based on the plurality of areas, and instructing the underwater robot to execute the cleaning task when a water entry signal is detected.

Optionally, after acquiring the current acceleration detected by the acceleration sensor and the distance parameter detected by the distance sensor when the underwater robot is executing the cleaning task, the method further includes:
if a change value of the distance value within the preset time period is greater than a preset change value, further acquiring a change level of the change value; and
when the change level is dangerous, controlling the underwater robot to execute a fourth escape action.

In addition, to achieve the above objective, the present application further provides an underwater robot. The underwater robot includes a memory, a processor, and an obstacle detection and control program stored in the memory, when the obstacle detection and control program is executed by the processor, the underwater robot is instructed to:
when the underwater cleaning robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining that a first-type obstacle is at a current position of the underwater robot; and
in response to detecting that the first-type obstacle is determined at the current position of the underwater robot, controlling a water pumping mechanism and an escape mechanism to execute a first escape action.

In addition, to achieve the above objective, the present application further provides a computer-readable storage medium on which a control program for an underwater robot is stored, wherein the control program is executed by a processor, the underwater robot is instructed to:
when the underwater robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining that a first-type obstacle is at a current position; and
in response to that the first-type obstacle is determined at the current position, controlling a water pumping mechanism and an escape mechanism to execute a first escape action.

Embodiments of the present application provide an obstacle detection and control method applied to an underwater robot, an underwater robot, and a storage medium. The method includes: when the underwater robot is executing a cleaning task, acquiring an acceleration detected by an acceleration sensor and a distance value detected by a distance sensor; when a variation of the acceleration within a preset time period is greater than a preset threshold and the distance value is greater than a distance threshold, determining that a first-type obstacle is at a current position; and in response to that the first-type obstacle is determined at a current position, controlling the water pumping mechanism and the escape mechanism to execute a first escape action. It can be learned that when the underwater robot executes a cleaning task, the type of the obstacle detected in the cleaning process is determined through data acquired by the acceleration sensor and the distance sensor based on the variation of the acceleration in the period threshold, and then a corresponding escape action is executed according to the type of the obstacle, so that the underwater robot is prevented from being trapped or changing the original traveling direction when encountering the obstacle, and the cleaning range and the cleaning efficiency of the underwater robot are further improved.

### BRIEF DESCRIPTION OF DRAWINGS

The accompanying drawings herein are incorporated into the specification and constitute a part of the specification, show embodiments conforming to the present application, and are used together with the specification to explain a principle of the present application. To describe the technical solutions in the embodiments of the present application more clearly, the following briefly describes the accompanying drawings that need to be used in embodiments. Apparently, those of ordinary skill in the art may still derive other accompanying drawings from these accompanying drawings without creative efforts.

FIG. 1 is a schematic flowchart of a first embodiment of an obstacle detection and control method for an underwater robot according to the present application;

FIG. 2 is a schematic flowchart of a second embodiment of an obstacle detection and control method for an underwater robot according to the present application;

FIG. 3 is a schematic flowchart of a third embodiment of an obstacle detection and control method for an underwater robot according to the present application;

FIG. 4 is a schematic flowchart of a fourth embodiment of an obstacle detection and control method for an underwater robot according to the present application; and

FIG. 5 is a schematic diagram of an embodiment of a terminal hardware structure of embodiments of an obstacle detection and control method for an underwater robot according to the present application.

The realization of the objectives, the functional features, and the advantages of the present application will be further explained in conjunction with the embodiments and with reference to the drawings.

### DETAILED DESCRIPTION OF EMBODIMENTS

It should be understood that the specific embodiments described herein are merely illustrative of the present application and do not limit the present application.

In the related art, when an underwater robot is executing a swimming pool cleaning task, obstacles at the bottom of the pool affect the underwater robot to execute the cleaning task. For example, when there are foreign objects such as swimming goggles, slippers and branches underwater, the underwater robot easily gets stuck and cannot move. Or when encountering fixed obstacles such as escalators and steps on the pool wall, the underwater robot changes the traveling direction due to the collision. This may cause the underwater robot to be trapped at a certain position or change the original traveling direction during the cleaning of the swimming pool, thereby affecting the cleaning range of the underwater robot.

To solve the above defects, an embodiment of the present application provides an obstacle detection and control method for an underwater robot, and a main solution thereof includes the following steps:
when the underwater robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining that a first-type obstacle is at a current position of the underwater robot; and
in response to that the first-type obstacle is determined at the current position, controlling a water pumping mechanism and an escape mechanism to execute a first escape action.

According to the obstacle detection and obstacle avoidance method for the underwater robot, when the underwater robot executes a cleaning task, the type of the obstacle detected in the cleaning process is determined through data acquired by the acceleration sensor and the distance sensor based on the variation of the acceleration in the period threshold, and then a corresponding escape action is executed according to the type of the obstacle, so that the underwater robot is prevented from being trapped or changing the original traveling direction when encountering the obstacle, and the cleaning range and the cleaning efficiency of the underwater robot are further improved.

For a better understanding of the above technical solutions, the following describes exemplary embodiments of the present application in detail with reference to the accompanying drawings. Although exemplary embodiments of the present disclosure are shown in the accompanying drawings, it should be understood that the present disclosure can be implemented in various forms and should not be limited to the embodiments set forth herein. Rather, these embodiments are provided to enable a more thorough understanding of the present disclosure and to fully convey the scope of the present disclosure to those skilled in the art.

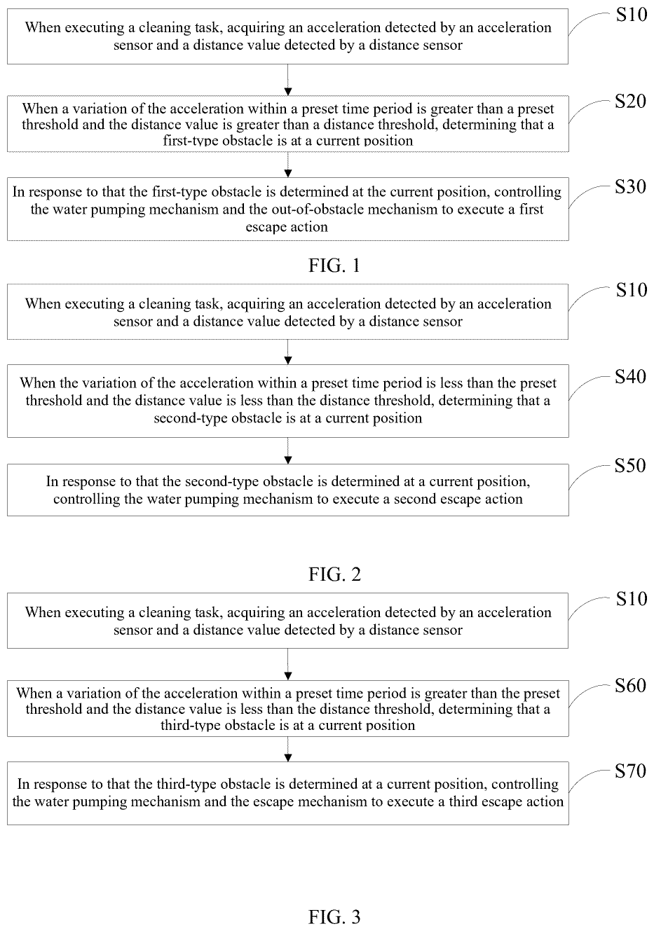

Referring to FIG. 1, FIG. 1 is a schematic flowchart of a first embodiment of an obstacle detection and control method for an underwater robot according to the present application.

In this embodiment, the obstacle detection and control method for the underwater robot includes the following steps:
Step S10: when the underwater robot is executing a cleaning task, acquiring an acceleration detected by an acceleration sensor and a distance value detected by a distance sensor.

In this embodiment, the underwater robot may be a pool cleaning robot, and the pool cleaning robot includes an escape mechanism and a water pumping mechanism. The distance sensor may be an ultrasonic sensor, a laser point cloud radar, a sonar sensor, a laser rangefinder, and the like. When the underwater robot is executing a swimming pool cleaning task, obstacles in the swimming pool, such as goggles, broken tiles, bricks, and pool walls, block the movement of the underwater robot, resulting in low efficiency of pool cleaning. Based on this, when encountering the above obstacles, the underwater robot is required to detect the type of obstacle and execute corresponding obstacle crossing based on different obstacles, thereby improving the efficiency of swimming pool cleaning.

Therefore, when the underwater robot receives a cleaning task and executes the cleaning task, an acceleration sensor and a distance sensor are started, the acceleration of the underwater robot currently detected by the acceleration sensor is acquired in real time, and a distance of an object 2-3 meters in front of the underwater robot is acquired by the ultrasonic sensor. Since the distance sensor has an induction blind spot, the acceleration sensor can be used as a supplementary detection method for the distance sensor. Based on the acceleration sensor, supplementary detection is performed at a detection blind spot of the distance sensor by a collision detection method corresponding to the acceleration sensor.

Optionally, the underwater robot can also scan obstacles 2-3 meters in front of the underwater robot by the point cloud radar.

It should be noted that, in this embodiment, when no obstacle is detected within 2-3 meters in front of the underwater robot, a distance value received by the distance sensor is considered to be greater than 3 meters.

Optionally, a planned cleaning path may also need to be determined before the underwater robot enters the water for pool cleaning to improve the cleaning efficiency of the underwater robot. In this embodiment, the underwater robot further includes a three-dimensional laser scanner. Therefore, before the step S10, the method further includes steps S40-S50:
Step S40: scanning a swimming pool area by a three-dimensional laser scanner, and dividing the swimming pool area into a plurality of areas each of an equal size based on a swimming pool area that is scanned by the three-dimensional laser; and
Step S50: generating a clean path planning solution based on the plurality of areas, and instructing the underwater robot to execute the clean path planning solution when a water entry signal is detected, wherein the clean path planning solution includes a target heading angle.

For example, before the underwater robot enters water for cleaning, a user may send a scanning instruction to the underwater robot through a mobile phone APP (application), and then the underwater robot scans the swimming pool through a three-dimensional laser scanner. To facilitate generation of a cleaning path, the underwater robot may divide a scanning result into a plurality of equal areas, and generate a cleaning path planning solution based on the plurality of equal areas, and when executing a cleaning task, the underwater robot may strictly travel in a traveling direction corresponding to the cleaning path planning solution.

It should be noted that the user may also send a scanning instruction to the underwater robot by other means, such as clicking a scan button, and may also scan the swimming pool by other devices. The above exemplary solutions are only used for explanation and are not intended to limit the present application.
Step S20: when a variation of the acceleration within a preset time period is greater than a preset threshold and the distance value is greater than a distance threshold, determining that a first-type obstacle is at a current position.

In this embodiment, the preset time period threshold may be set between 10 ms and 30 ms, the time period threshold may be selected within a range of 10 ms to 500 ms, and a longer period threshold may also be set. To avoid the influence of underwater resistance, a starting point of the period threshold is not 0 ms. For the convenience of calculation, the variation of the acceleration is taken as an absolute value. The preset threshold may be set based on an actual application scenario. The distance threshold may be 0.2 m, 0.5 m, or 1 m, and may be set reasonably based on an actual requirement. The first-type obstacle refers to small obstacles at the bottom of the swimming pool that are far away from the pool wall directly in front of the underwater robot, such as goggles, bricks, and branches.

Optionally, if an acceleration sensor value is set to sensor val and an actual acceleration is set to acc_val, a change value of the acceleration may be calculated by the following formula:

$$acc\_val = C \times sensor\_val .$$

Where C is a conversion coefficient, the acceleration sensor value under the gravity acceleration is 4096, and if the gravity acceleration is 980 cm/s², the conversion coefficient C is the quotient of 980 and 4096, that is, C is about 0.239258. Therefore, the above formula is specifically:

$$acc\_val = 0.239258 \times sensor\_val .$$

When a variation of the acceleration within a preset time period is greater than a preset threshold and a distance value detected by the distance sensor is greater than a distance threshold, the underwater robot contacts an obstacle at a current position, and the obstacle affects the cleaning work of the underwater robot. In this case, the underwater robot may determine that the first-type obstacle is at a current position.

The type of the current obstacle is determined by the acceleration of the underwater robot acquired by the acceleration sensor in real time and the distance value acquired by the distance sensor, so that the underwater robot can correspondingly avoid the obstacle according to the current distance from the obstacle, thus preventing the obstacle from having a negative impact on the cleaning work of the underwater robot.
Step S30: in response to that the first-type obstacle is determined at a current position, controlling a water pumping mechanism and an escape mechanism to execute a first escape action.

In this embodiment, in response to that the first-type obstacle is determined at a current position, the water pumping mechanism and the escape mechanism of the underwater robot need to be controlled to execute the first escape action, so that the underwater robot crosses the current first-type obstacle.

Specifically, this step includes steps S31-S32:
Step S31: in response to that the first-type obstacle is determined at a current position, stopping the water pumping mechanism and starting the escape mechanism thereby switching an operating state of the underwater robot to; and
Step S32: controlling the underwater robot to execute the first escape action for a first preset duration when the operating state is switched.

In this embodiment, discharge ports are provided at a bottom in front of the underwater robot and a top of the underwater robot. When the underwater robot is executing a cleaning work, the water pumping mechanism works normally and the water flows out from the discharge ports at the top.

In an embodiment, in response to that the first-type obstacle is determined at a current position of the underwater robot, the water pumping mechanism is stopped, and the escape mechanism is started. After the escape mechanism is started, the water flow of the underwater robot changes from flowing out from the drainage ports at the top to flowing out from the drainage ports at the bottom directly in front, that is, the operating state is switched. After the water flows out from the drainage ports at the bottom in front, a front end of the underwater robot is lifted to a preset angle, so that the underwater robot can cross the first-type obstacle (such as goggles, bricks, and branches), and continue to execute the cleaning task after crossing the first-type obstacle within a first preset duration. Therefore, the first escape action is to close the water pumping mechanism and then change the water draining mode of the underwater robot by the escape mechanism, so that the underwater robot can cross the first-type obstacle within a first preset duration, thereby improving the cleaning efficiency of the underwater robot. It should be noted that the first preset duration may be set based on an actual scenario.

According to the technical solution disclosed in the embodiment, during a process of the underwater robot executing a cleaning task, an acceleration detected by the acceleration sensor and a distance value detected by the distance sensor are acquired, and when a variation of the acceleration within a preset time period is greater than a preset threshold and the distance is greater than a distance threshold, a first-type obstacle is at the current position. Based on this, the underwater robot can detect the underwater obstacle by the variation of the acceleration in the acceleration sensor within a preset time period and the distance value of the distance sensor, and further the underwater robot can detect the obstacle. When the first-type obstacle is detected, a first escape action is executed, so that the underwater robot can achieve escape quickly, and the cleaning efficiency is improved.

Referring to FIG. 2, in a second embodiment, based on the first embodiment, after the step S10, the method further includes steps S40-S50:
Step S40: when the variation of the acceleration within the preset time period is less than the preset threshold and the distance value is less than the distance threshold, determining that a second-type obstacle is at a current position.

In this embodiment, the preset threshold may be set based on an actual application scenario. The distance threshold may be 0.2 m, 0.5 m, or 1 m, and may be set reasonably based on an actual requirement. The second-type obstacle includes a step, a pool wall, and a floor drain.

In an embodiment, when a variation of the acceleration within a preset time period is less than a preset threshold and the distance value detected by the distance sensor is less than a distance threshold, the underwater robot detects that there is a second-type obstacle such as a step, a pool wall and a floor drain in front of a current position. In this case, the underwater robot may judge that there is the second-type obstacle at a current position. It should be noted that the obstacle such as a step, a pool wall and a floor drain can be detected by the underwater robot by a distance sensor. That is, the second-type obstacle may be an obstacle that can be detected only by a distance sensor. Meanwhile, the first-type obstacle is an obstacle that needs to be detected by an acceleration sensor, and may be considered as an obstacle in an area corresponding to a detection blind spot of the distance sensor. Therefore, when the first-type obstacle is detected, the underwater robot can execute the action of crossing the first-type obstacle, and the first-type obstacle is prevented from affecting the cleaning work of the underwater robot; when the second-type obstacle such as a step or a pool wall is detected, the underwater robot needs to cross the step or climb up the pool wall for cleaning, so that the step or the pool wall is prevented from affecting the cleaning work of the underwater robot.

Based on this, the type of the current obstacle is determined by the acceleration of the underwater robot acquired by the acceleration sensor in real time and the distance value acquired by the distance sensor.
Step S50: in response to that the second-type obstacle is determined at a current position, controlling the water pumping mechanism to execute a second escape action.

In this embodiment, in response to that a second-type obstacle is determined at the current position, the water pumping mechanism of the underwater robot needs to be controlled to execute a second escape action, so that the underwater robot can cross the step or climb up the pool wall, and the underwater robot can easily cross the second-type obstacle, thereby improving the cleaning efficiency of the underwater robot in the pool.

Specifically, this step includes steps S51-S52:
Step S51: in response to that the second-type obstacle is determined at a current position, controlling the water pumping mechanism to switch an operating state; and
Step S52: controlling the underwater robot to execute the second escape action for a second preset duration when the operating state of the water pumping mechanism is switched.

In this embodiment, in response to that the second-type obstacle is determined at the current position, the water pumping mechanism is controlled to switch an operating state. The water pumping mechanism after switching the operating state can make the water flow of the underwater robot change from flowing out from the drainage ports at the top to flowing out from the drainage ports at the bottom directly in front. After the water flows out from the drainage ports at the bottom in front, a front end of the underwater robot is lifted to a preset angle, so that the underwater robot can cross the step or climb up the pool wall within a second preset duration, and continue to execute the cleaning task after crossing the second-type obstacle.

Therefore, the second escape action is to switch the operating state of the water pumping mechanism, so that the underwater robot can cross the second-type obstacle within a second preset duration, thereby improving the cleaning efficiency of the underwater robot. It should be noted that the second preset duration may be set based on an actual scenario.

According to the technical solution disclosed in the embodiment, during a process of the underwater robot executing a cleaning task, an acceleration detected by the acceleration sensor and a distance value detected by the distance sensor are acquired, and when a variation of the acceleration within a preset time period is less than a preset threshold and the distance is less than a distance threshold, there is a second-type obstacle at a current position. Based on this, the underwater robot can detect the underwater obstacle by the variation of the acceleration in the acceleration sensor within a preset time period and the distance value of the distance sensor, and further the underwater robot can detect the obstacle. When the second-type obstacle is detected, a second escape action is executed, so that the underwater robot can achieve escape quickly, and the cleaning efficiency is improved.

Referring to FIG. 3, in a third embodiment, based on the first embodiment, after the step S10, the method further includes steps S60-S70:
Step S60: when a variation of the acceleration within a preset time period is greater than the preset threshold and the distance value is less than the distance threshold, determining that a third-type obstacle is at a current position.

In this embodiment, the preset threshold may be set based on an actual application scenario. The distance threshold may be 0.2 m, 0.5 m, or 1 m, and may be set reasonably based on an actual requirement. The third-type obstacle consists of a first-type obstacle and a second-type obstacle, such as a brick near the pool wall.

In an embodiment, when a variation of the acceleration within a preset time period is greater than a preset threshold and the distance value detected by the distance sensor is less than a distance threshold, the underwater robot determines that a first-type obstacle such as a brick and a branch is at a current position after determining a second-type obstacle such as a step and a pool wall. In this case, the underwater robot may judge that there is the third-type obstacle at a current position.

Based on this, the type of the current obstacle is determined by the acceleration of the underwater robot acquired by the acceleration sensor in real time and the distance value acquired by the distance sensor.
Step S70: in response to that the third-type obstacle is determined at a current position, controlling the water pumping mechanism and the escape mechanism to execute a third escape action.

In this embodiment, in response to that a third-type obstacle is determined at a current position, the water pumping mechanism and the escape mechanism need to be controlled first to execute a first escape action and then execute a second escape action after executing the first escape action, so that the underwater robot can cross the swimming goggle, the brick or the branch and then cross the step or climb up the pool wall, and further the underwater robot can cross the third-type obstacle, thereby improving the cleaning efficiency of the underwater robot in the swimming pool.

Specifically, this step includes steps S71-S72:
Step S71: in response to that the third-type obstacle is determined at a current position, stopping the water pumping mechanism and starting the escape mechanism to enable the underwater robot to execute the third escape action for a third preset duration; and
Step S72: when the distance value is detected as zero (0), stopping the escape mechanism, starting the water pumping mechanism, and controlling the underwater robot to execute the third escape action for the third preset duration.

In this embodiment, in response to that the third-type obstacle is determined at a current position, the first-type obstacle needs to be crossed, that is, the water pumping mechanism is stopped, the escape mechanism is started to execute the first escape action for a third preset duration, and the underwater robot needs to continuously cross the second-type obstacle after crossing the first-type obstacle. Therefore, after the first-type obstacle is crossed, when the distance value detected by the distance sensor is 0, that is, the front end of the underwater robot contacts the second-type obstacle such as a step or a pool wall, the second escape action is performed. That is, the escape mechanism is stopped, the water pumping mechanism is restarted, and the water pumping mechanism is controlled to maintain or switch the current operating state, so that the water flow of the underwater robot flows out from the discharge ports at the bottom right in front, the front end of the underwater robot is further ensured to be lifted by a preset angle, and the underwater robot crosses the step or climbs up the pool wall within a third preset duration and then continuously executes the cleaning task.

Therefore, the third escape action is to sequentially execute the first escape action and the second escape action, so that the underwater robot continuously crosses the second-type obstacles after crossing the first-type obstacle. A switching condition from the first escape action to the second escape action is that the distance value detected by the distance sensor is 0. That is, the underwater robot contacts the second-type obstacle such as the pool wall or the step.

It should be noted that the third preset duration may be set based on an actual scenario.

According to the technical solution disclosed in the embodiment, when the underwater robot is executing a cleaning task, an acceleration detected by the acceleration sensor and a distance value detected by the distance sensor are acquired, and when a variation of the acceleration within a preset time period is greater than a preset threshold and the distance is less than a distance threshold, a third-type obstacle is determined at a current position. Based on this, the underwater robot can detect the underwater obstacle by the variation of the acceleration in the acceleration sensor within a preset time period and the distance value of the distance sensor, and further the underwater robot can determine the obstacle. When the third-type obstacle is determined, a third escape action is executed, so that the underwater robot can achieve escape quickly, and the cleaning efficiency is improved.

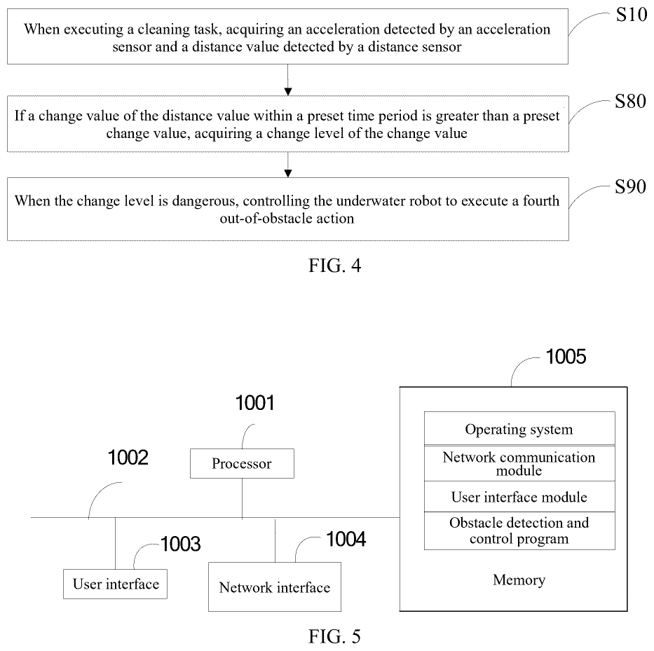

Referring to FIG. 4, in a fourth embodiment, based on the first embodiment, after the step S10, the method further includes steps S80-S90:
Step S80: if a change value of the distance value within a preset time period is greater than a preset change value, further acquiring a change level of the change value.

In this embodiment, if a change value of the distance value within a preset time period is greater than a preset change value, that is, an ultrasonic distance detected by the ultrasonic sensor has an excessively fast change amplitude, the ultrasonic sensor of the underwater robot may be considered to detect a movable obstacle, such as another underwater robot. Based on this, when a change value of the distance value is greater than a preset change value, a change level of the change value may be acquired. The change level may be set based on a ratio of the change value to a preset change value, for example, when the change value is more than 1.5 times the preset change value, the current change level may be considered dangerous.

For example, if the underwater robot detects an obstacle and a distance from the obstacle is 3 meters, the underwater robot travels 1 meter after 5 seconds, and the distance from the detected obstacle is only 1 meter, that is, the change value of the distance is 40 cm/s. Based on this, the change level of the current distance value may be judged to be dangerous.

It should be noted that the above parameters are only used for explanation and are not limitations on the solution. The actual data needs to be set based on a specific application scenario.
Step S90: when the change level is dangerous, controlling the underwater robot to execute a fourth escape action.

In this embodiment, a fourth escape action may be an action of controlling the underwater robot to execute a left turn or a right turn. If the change level of the distance value is dangerous, other underwater robots may move in the same direction as the current underwater robot. Based on the change level, the traveling motor of the underwater robot can be controlled to move leftwards, so that the cleaning process is prevented from being affected due to violent collision with the movable obstacle.

According to the technical solution disclosed in the embodiment, the change value of the distance value in the preset time period is calculated. When the change value is greater than the preset change value, the change level is further calculated. When the change level is dangerous, there is a movable obstacle directly in front of the underwater robot. Based on this, to protect the safety of the cleaning robot of the underwater robot, the underwater robot needs to be controlled to limit the fourth escape action, so that the underwater robot avoids the movable obstacle and ensures that the underwater robot can successfully complete the cleaning task.

Referring to FIG. 5, FIG. 5 is a schematic diagram of a terminal structure of a hardware operating environment according to an embodiment of the present application.

As shown in FIG. 5, the terminal may include: a processor 1001 such as a CPU, a network interface 1004, a user interface 1003, a memory 1005, and a communication bus 1002. The communication bus 1002 is configured to implement connection and communication between these components. The user interface 1003 may include a display and an input unit such as a keyboard. Optionally, the user interface 1003 may also include a standard wired interface and a wireless interface. The network interface 1004 may optionally include a standard wired interface, and a wireless interface (e.g., a WI-FI interface). The memory 1005 may be a high-speed RAM memory or a non-volatile memory such as a disk memory. Optionally, the memory 1005 may be a storage device separate from the processor 1001.

Those skilled in the art may understand that the terminal structure shown in FIG. 5 does not constitute any limitation on the terminal. The terminal may include more or fewer components than those shown in the figure, or some components may be combined, or a different component deployment may be used.

As shown in FIG. 5, a memory 1005, as a computer storage medium, may include an operating system, a data storage module, a network communication module, and an obstacle detection and control program.

In the terminal shown in FIG. 5, the network interface 1004 is mainly used to connect a background server and perform data communication with the background server; and the processor 1001 may call an obstacle detection and control program stored in the memory 1005 and perform the following operations:
when the underwater robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining a first-type obstacle is at a current position; and
in response to that the first-type obstacle is determined at the current position, controlling a water pumping mechanism and an escape mechanism to execute a first escape action.

Further, the processor 1001 may call an obstacle detection and control program stored in the memory 1005 and perform the following operations:
in response to that the first-type obstacle is at a current position, stopping the water pumping mechanism and starting the escape mechanism to switch the underwater robot to an operating state; and
controlling the underwater robot to execute the first escape action for a first preset duration when the operating state is switched.

Further, the processor 1001 may call an obstacle detection and control program stored in the memory 1005 and perform the following operations:
when the variation of the acceleration within a preset time period is less than the preset threshold and the distance value is less than the distance threshold, determining a second-type obstacle is at a current position; and
in response to that the second-type obstacle is determined at a current position, controlling the water pumping mechanism to execute a second escape action.

Further, the processor 1001 may call an obstacle detection and control program stored in the memory 1005 and perform the following operations:
in response to that the second-type obstacle is determined at a current position, controlling the water pumping mechanism to switch an operating state; and
controlling the underwater robot to execute the second escape action for a second preset duration when the operating state of the water pumping mechanism is switched.

Further, the processor 1001 may call an obstacle detection and control program stored in the memory 1005 and perform the following operations:
when a variation of the acceleration within a preset time period is greater than the preset threshold and the distance value is less than the distance threshold, determining a third-type obstacle is at a current position; and
in response to that the third-type obstacle is determined at a current position, controlling the water pumping mechanism and the escape mechanism to execute a third escape action.

Further, the processor 1001 may call an obstacle detection and control program stored in the memory 1005 and perform the following operations:
in response to that the third-type obstacle is determined at a current position, stopping the water pumping mechanism and starting the escape mechanism to enable the underwater robot to execute the third escape action for a third preset duration; and
when the distance value is detected as zero (0), stopping the escape mechanism, starting the water pumping mechanism, and controlling the underwater robot to execute the third escape action for the third preset duration.

Further, the processor 1001 may call an obstacle detection and control program stored in the memory 1005 and perform the following operations:
scanning a swimming pool area by a three-dimensional laser scanner, and dividing the swimming pool area into a plurality of areas with equal size based on a swimming pool area that is scanned by the three-dimensional laser; and
generating the cleaning task based on the plurality of areas, and instructing the underwater robot to execute the cleaning task when a water entry signal is detected.

Further, the processor 1001 may call an obstacle detection and control program stored in the memory 1005 and perform the following operations:
if a change value of the distance value within a preset time period is greater than a preset change value, acquiring a change level of the change value; and
when the change level is dangerous, controlling the underwater robot to execute a fourth escape action.

In addition, those of ordinary skill in the art can understand that all or part of the processes in the method of the above embodiment can be completed by instructing related hardware through a computer program. The computer program includes program instructions, and the computer program may be stored in a storage medium that is a computer-readable storage medium. The program instructions are executed by at least one processor in the control terminal to implement the process steps of the embodiment of the above method.

Therefore, the present application further provides a computer-readable storage medium on which a control program for an underwater robot is stored, wherein when the control program for the underwater robot is executed by a processor, the steps of the obstacle detection and control method for the underwater robot described in the above embodiment are implemented.

It should be noted that, since the storage medium provided in the embodiment of the present application is the storage medium used to implement the method of the embodiment of the present application, based on the method introduced in the embodiment of the present application, those skilled in the art can understand the specific structure and deformation of the storage medium, and details are not described herein again. Any storage medium used in the method of the embodiment of the present application is within the protection scope of the present application.

It should be appreciated by those skilled in the art that embodiments of the present application may be provided as a method, a system, or a computer program product. Therefore, the present application may use a form of hardware only embodiments, software only embodiments, or embodiments with a combination of software and hardware. In addition, the present application may use a form of a computer program product that is implemented on one or more computer-usable storage media (including but not limited to a disk memory, a CD-ROM, and an optical memory) that include computer-usable program code.

The present application is described with reference to the flowcharts and/or block diagrams of the method, the device (system), and the computer program product according to the embodiments of the present application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may alternatively be stored in a computer-readable memory that can instruct a computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

These computer program instructions may alternatively be loaded onto the computer or another programmable data processing device, so that a series of operations and steps are performed on the computer or another programmable device, to generate computer-implemented processing. Therefore, the instructions executed on the computer or another programmable device provide steps for implementing a specific function in one or more processes in the flowcharts and/or in one or more blocks in the block diagrams.

It should be noted that, in the claims, any reference signs placed between parentheses shall not be constructed as limiting the claim. The word “comprise” does not exclude the presence of elements or steps not listed in the claim. The word “a” or “an” preceding an element does not exclude the presence of a plurality of such elements. The present application can be implemented by means of hardware including several distinct elements, and by means of a suitably programmed computer. In a unit claim enumerating several means, several of these means may be embodied by the same item of hardware. The usage of the words such as “first”, “second” and “third” do not indicate any order. These words may be interpreted as names.

Although some preferred embodiments of the present application have been described, those skilled in the art can make changes and modifications to these embodiments after learning the basic inventive concept. Therefore, the appended claims are intended to be construed as including the preferred embodiments and all changes and modifications that fall within the scope of the present application.

It is clear that those skilled in the art can make various modifications and variations to the present application without departing from the spirit and scope of the present application. In this way, the present application is intended to cover these modifications and variations of the present application provided that these modifications and variations fall within the scope of protection defined by the following claims and their equivalent technologies.

The above mentioned contents are merely preferred embodiments of the present application and are not intended to limit the patent scope of the present application. The equivalent structure or equivalent process transformation made by using the contents of the specification and the drawings of the present application, or direct or indirect applications to other related technical fields, are all included in the patent protection scope of the present application.

1. An obstacle detection and control method applied to an underwater robot, the underwater robot comprising an escape mechanism and a water pumping mechanism, wherein the obstacle detection and control method for the underwater robot comprises:
when the underwater robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining that a first-type obstacle is at a current position of the underwater robot; and
in response to that the first-type obstacle is determined at the current position, controlling the water pumping mechanism and the escape mechanism to execute a first escape action.

2. The obstacle detection and control method for the underwater robot according to claim 1, wherein controlling the water pumping mechanism and the escape mechanism to execute the first escape action in response to that the first-type obstacle is determined at a current position comprises:
in response to that the first-type obstacle is determined at a current position, stopping the water pumping mechanism and starting the escape mechanism thereby switching an operating state of the underwater robot; and
controlling the underwater robot to execute the first escape action for a first preset duration when the operating state is switched.

3. The obstacle detection and control method for the underwater robot according to claim 1, after acquiring the acceleration detected by the acceleration sensor and the distance value detected by the distance sensor during a process of executing a cleaning task, the method further comprising:
when the variation of the acceleration within the preset time period is less than the preset threshold and the distance value is less than the distance threshold, determining that a second-type obstacle is at the current position of the underwater robot; and
in response to that the second-type obstacle is determined at the current position, controlling the water pumping mechanism to execute a second escape action.

4. The obstacle detection and control method for the underwater robot according to claim 3, wherein controlling the water pumping mechanism to execute a second escape action in response to that the second-type obstacle is determined at a current position comprises:
in response to that the second-type obstacle is determined at a current position, controlling the water pumping mechanism to switch an operating state; and
controlling the underwater robot to execute the second escape action for a second preset duration when the operating state of the water pumping mechanism is switched.

5. The obstacle detection and control method for the underwater robot according to claim 1, after acquiring the current acceleration rate detected by the acceleration sensor and the distance parameter detected by the distance sensor during a process of executing a cleaning task, the method further comprising:
when a variation of the acceleration within a preset time period is greater than the preset threshold and the distance value is less than the distance threshold, determining that a third-type obstacle is at the current position of the underwater robot; and
in response to that the third-type obstacle is determined at the current position, controlling the water pumping mechanism and the escape mechanism to execute a third escape action.

6. The obstacle detection and control method for the underwater robot according to claim 5, wherein controlling the water pumping mechanism and the escape mechanism to execute the third escape action in response to that the third-type obstacle is determined at the current position comprises:
in response to detecting that there is the third-type obstacle at a current position, stopping the water pumping mechanism and starting the escape mechanism by the underwater robot to execute the third escape action for a third preset duration; and
when the distance value is detected as zero (0), stopping the escape mechanism, starting the water pumping mechanism, and controlling the underwater robot to execute the third escape action for the third preset duration.

7. The obstacle detection and control method for the underwater robot according to claim 1, wherein the underwater robot comprises a three-dimensional laser scanner, and before acquiring a current acceleration detected by the acceleration sensor and the distance value detected by the distance sensor when the underwater robot is executing the cleaning task, the method further comprising:
scanning a swimming pool area by a three-dimensional laser scanner, and dividing the swimming pool area into a plurality of areas each of an equal size based on a swimming pool area that is scanned by the three-dimensional laser; and
generating the cleaning task based on the plurality of areas, and instructing the underwater robot to execute the cleaning task when a water entry signal is detected.

8. The obstacle detection and control method for the underwater robot according to claim 1, after acquiring the current acceleration detected by the acceleration sensor and the distance parameter detected by the distance sensor when the underwater robot is executing the cleaning task, the method further comprising:
if a change value of the distance value within the preset time period is greater than a preset change value, further acquiring a change level of the change value; and
when the change level is dangerous, controlling the underwater robot to execute a fourth escape action.

9. An underwater robot comprising: a memory, a processor, and an obstacle detection and control program stored in the memory, when and the obstacle detection and control program is executed by the processor, the underwater robot is instructed to:
when the underwater cleaning robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining a first-type obstacle is at a current position of the underwater robot; and
in response to that the first-type obstacle is determined at the current position, controlling a water pumping mechanism and an escape mechanism to execute a first escape action.

10. A computer-readable storage medium on which a control program for an underwater robot is stored, wherein the control program is executed by a processor, the underwater robot is instructed to:
when the underwater robot is executing a cleaning task, acquiring an acceleration detected by an acceleration sensor and a distance value detected by a distance sensor;
when a variation of the acceleration within a preset time period is greater than a preset threshold and the distance value is greater than a distance threshold, determining that a first-type obstacle is at a current position; and
in response to that the first-type obstacle is determined at the current position, controlling the water pumping mechanism and the escape mechanism to execute a first escape action.
